(19) United States
(12) Patent Application Publication
(10) Pub. No.: US 2014/0300440 A1
(43) Pub. Date: Oct. 9, 2014

(54) INDUCTOR GAP SPACER

(71) Applicant: HAMILTON SUNDSTRAND CORPORATION, Windsor Locks, CT (US)

(72) Inventors: Andreas C. Koenig, Machesney Park, IL (US); Joshua Scott Parkin, Loves Park, IL (US)

(73) Assignee: Hamilton Sundstrand Corporation, Windsor Locks, CT (US)

(21) Appl. No.: 13/857,471

(22) Filed: Apr. 5, 2013

(51) Int. Cl. H01F 3/14; H01F 41/06

(52) U.S. Cl. CPC H01F 3/14; H01F 41/0616
USPC 336/178; 29/605

(57) ABSTRACT

An inductor comprises a ferromagnetic or ferrimagnetic core with a reluctance gap, a plurality of conductive windings disposed about the ferromagnetic or ferrimagnetic core, and a spacer. The spacer separates the conductive windings from the ferromagnetic or ferrimagnetic core in the immediate vicinity of the reluctance gap, such that the conductive windings are substantially unaffected by fringing flux from the reluctance gap.

### STATEMENT OF GOVERNMENT INTEREST

This invention was made with government support under FA8650-07-2-2739 awarded by the United States Air Force. The government has certain rights in the invention.

### BACKGROUND

The present invention relates generally to power conversion magnetics, and more particularly to high frequency inductors.

Inductors respond to changes in current by producing an electromotive force (EMF) according to Faraday's law, and are used in a wide variety of analog processing and power conversion applications. Conventional inductors typically comprise at least one ferromagnetic or ferrimagnetic core wrapped with a plurality of conductive windings. Transformers and other inductor-based power conversion tools use multiple windings to transform voltages, and are used ubiquitously in electrical power transmission, distribution, and supply applications. Single inductors are used in a wide range of signal and data processing applications.

Some inductors use gapped cores to mitigate excessive flux. Gapped core inductor constructions interrupt the ferromagnetic or ferrimagnetic core of the inductor with a narrow nonconductive and nonmagnetic gap. This gap may, for instance, be filled with air or another suitable non-conductivity, nonmagnetic material, and increases the overall reluctance of the inductor. Changing fringing flux near gaps in such inductors can induce deleterious eddy currents in surrounding windings. High frequency inductors experience correspondingly large changes in fringing flux, and eddy currents in such applications can considerably reduce inductor efficiency.

A variety of techniques have been used to minimize eddy currents through inductor windings and the magnetic core. Inductors are often constructed with laminated cores to reduce eddy currents. Additionally or alternatively, some inductors use multiple parallel strands of narrow gauge wire (e.g. Litz wire) for inductor windings to minimize the magnitude of fringing flux effects.

### SUMMARY

In a first embodiment of the present invention, an inductor comprises a ferromagnetic or ferrimagnetic core with a reluctance gap, a plurality of conductive windings disposed about the ferromagnetic or ferrimagnetic core, and a spacer. The spacer separates the conductive windings from the ferromagnetic or ferrimagnetic core in the immediate vicinity of the reluctance gap, such that the conductive windings are substantially unaffected by fringing flux from the reluctance gap.

In a second embodiment of the present invention, a method of constructing an inductor comprises forming a ferromagnetic or ferrimagnetic core with a reluctance gap having a gap width, surrounding a region of the ferromagnetic or ferrimagnetic core adjacent the reluctance gap with a non-conductive spacer, and wrapping the ferromagnetic or ferrimagnetic core with conductive windings, such that the non-conductive, non-magnetic spacer distances the conductive windings from the reluctance gap.

### BRIEF DESCRIPTION OF THE DRAWINGS

FIG. 1 is a schematic cross-sectional view of a three-leg inductor according to one embodiment of the present invention.

FIG. 2 is an expanded view of one leg of the inductor of FIG. 1 around a reluctance gap.

### DETAILED DESCRIPTION

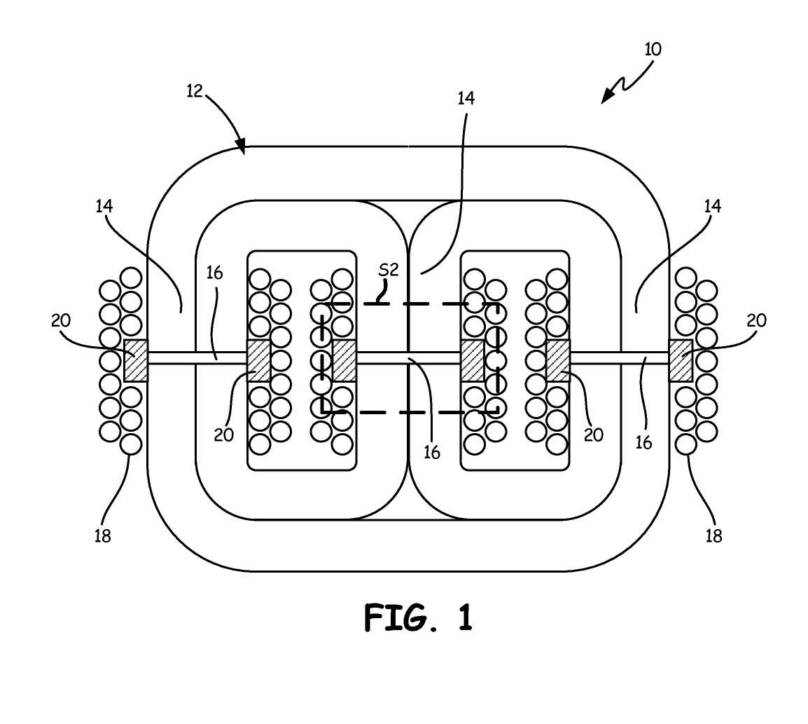

FIG. 1 is a schematic cross-sectional view of inductor 10, which comprises core 12, cores 14, reluctance gaps 16, windings 18, and spacers 20. Inductor 10 is a three-leg gapped inductor, and may for instance be a power or signal conversion inductor. Core 12 is a solid “E” shaped structure formed of a ferromagnetic or ferrimagnetic material such as steel or ferrite. In some instances, core 12 may a laminated structure comprised of a plurality of thin sheet laminations. Core 12 may be formed as a unitary piece, or as a plurality of distinct but connected pieces, as in the depicted embodiment. As illustrated in FIG. 1, core 12 has three legs 14, each of which forms a section of core 12. Legs 14 have reluctance gaps 16, which may for instance be air gaps or gaps filled with another non-conductive, non-magnetic material. Legs 14 are wrapped with windings 18 near reluctance gaps 16. Windings 18 may, for example, be coils of wires wrapped about legs 14 in the vicinity of reluctance gaps 16. In some such embodiments windings 18 may comprise a large number of Litz wires or other fine gauge wires to reduce the proportion of windings 18 affected by fringing flux from reluctance gaps 16. In alternative embodiments, windings 18 may be laminated windings formed in layers about legs 14. Windings 18 can be electrically connected to electrical components, e.g. via leads or terminal contacts. Although inductor 10 is depicted as a three-leg inductor, the present invention may be practiced with any number of legs. Inductor 10 may, for instance, be a two-leg transformer or a single-winding analog signal conditioning inductor.

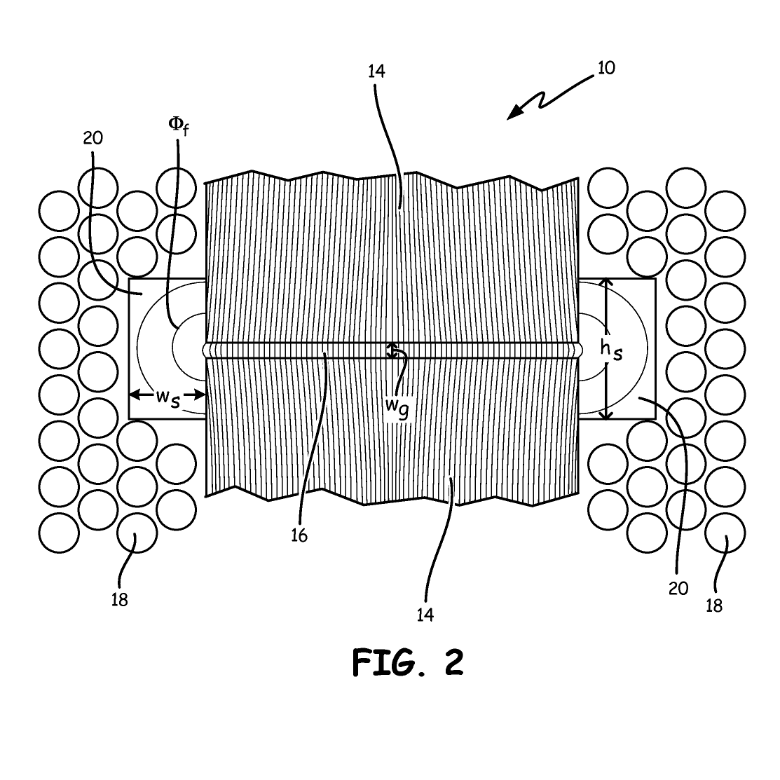

Current through windings 18 creates magnetic flux through leg 14. As current through windings 18 changes (e.g. with AC current), magnetic flux through leg 14 correspondingly changes, inducing an EMF (voltage) across windings 18 proportional to and opposing the change in magnetic flux. In some instances, inductor 10 may use multiple electrically separate sets of windings 18, such that AC current flow through one set of windings induces current flow through another. Although the flux induced by current flow through windings 18 is primarily contained within core 12 and reluctance air gap 16, some fringing flux escapes near reluctance gap 16. This fringing flux can in turn induce eddy currents through nearby windings 18, increasing the AC resistance of windings 18 and correspondingly lowering the efficiency of inductor 10. To minimize efficiency losses due to eddy currents, spacers 20 are disposed about reluctance gaps 16, such that no windings 18 are located in the immediate vicinity of reluctance gaps 16, as described in further detail below with respect to FIG. 2.

FIG. 2 is an expanded view of a region of inductor 10 surrounding reluctance gap 16 and including spacer 20. This region is labeled with section box S2 in FIG. 1. FIG. 2 illustrates leg 14, reluctance gap 16, windings 18, spacer 20, gap width w_{g}, spacer width wₛ, spacer height hₛ, and fringing flux Φ_{f}. As described above with respect to FIG. 1, inductor 10 is a gapped inductor with at least one leg 14 formed of a ferromagnetic or ferrimagnetic material, and interrupted by reluctance gap 16. Reluctance gap 16 extends fully across the leg 14, and is characterized by a gap width w_{g} between separated sections of leg 14.

FIG. 2 shows flux lines through leg 14 corresponding to flux created by current flow through windings 18. This flux escapes leg 14 near air gap 16 as fringing flux Φ_{f}. Where fringing flux Φ_{f} impinges upon windings 18, changes in fringing flux Φ_{f} induce eddy currents in windings 18 that increase the temperature and AC resistance of windings 18, reducing the overall efficiency of inductor 10. This effect is particularly pronounced at high frequencies. To minimize this effect, windings 18 are distanced from leg 14 by spacer 20, which is centered on reluctance gap 16. Spacer 20 extends fully around leg 14, and provides a region immediately surrounding reluctance gap 16 wherein no windings 18 are situated. Spacer 20 is formed of a non-conductive, non-magnetic material, which may for instance be a paper or polymer. Spacer 20 may, in some embodiments, comprise several layers of Nomex sheets formed around leg 14. Alternatively, spacer 20 may comprise several layers of Kapton tape wrapped around leg 14.

Fringing flux Φ_{f} drops off with distance from reluctance gap 16. This drop-off depends on the particular geometry of leg 14 and reluctance gap 16, such that the magnitude of Φ_{f} at distances greater than gap width w_{g} from reluctance gap 16 is typically negligible. Accordingly, to avoid eddy currents in windings 18, spacer 20 is selected to distance all windings at least a distance equal to gap width w_{g} away from reluctance gap 16. This is done by providing spacer 20 with spacer width wₛ>w_{g}, and spacer height hₛ>2w_{g}. To avoid wasting space within inductor 10, while ensuring that eddy currents from fringing flux are minimized, spacer dimensions may for instance be limited to twice or three times these limits, e.g. spacer width wₛ<2_{g} or wₛ<3_{g}, and spacer height hₛ<4w_{g} or hₛ<4w_{g}. Spacer 20 may be formed with a rectangular cross-section as depicted in FIGS. 1 and 2, with a half-circle cross-section having a radius r=wₛ>w_{g}, or as any other appropriate shape sufficient to distance windings 18 at least gap width w_{g} away from reluctance gap 16.

Inductor 12 is constructed by first fabricating (e.g. casting, laminating, assembling from pieces) legs 14 to form core 12, then forming spacers 20 around reluctance gaps 16 of each leg 14. Spacers 20 may, for instance, be deposited, laminated, or otherwise formed in place on each leg 14. Alternatively, spacers 20 may be wrapped around and secured to each leg 14. Once spacers 20 are in place, windings 18 are wrapped around leg 14 and spacers 20. Spacers 20 provide an efficient and inexpensive solution to decrease winding AC resistance due to eddy currents induced by fringing flux from reluctance gaps 16.

### Discussion of Possible Embodiments

The following are non-exclusive descriptions of possible embodiments of the present invention.

An inductor comprises a ferromagnetic or ferrimagnetic core with a reluctance gap, a plurality of conductive windings disposed about the ferromagnetic or ferrimagnetic core, and a spacer. The spacer separates the conductive windings from the ferromagnetic or ferrimagnetic core in the immediate vicinity of the reluctance gap, such that the conductive windings are substantially unaffected by fringing flux from the reluctance gap.

The inductor of the preceding paragraph can optionally include, additionally and/or alternatively, any one or more of the following features, configurations, and/or additional components:

The spacer has a semicircular cross-section.

The spacer has a rectangular cross-section.

The spacer is formed of polymer.

The spacer is formed from a Nomex sheet.

The spacer is formed of paper.

The spacer is formed of Kapton tape.

The inductor comprises a plurality of distinct cores, each having a reluctance gap surrounded by a corresponding spacer.

The inductor comprises three legs.

The spacer has a width at least as wide as the reluctance gap.

The spacer has a width no more than twice as wide as the reluctance gap.

The spacer has a width no more than three times as wide as the reluctance gap.

The spacer has a height at least twice a width of the reluctance gap.

The spacer has a height no more than four times a width of the reluctance gap.

The spacer has a height no more than six times a width of the reluctance gap.

A method of constructing an inductor comprises forming a ferromagnetic or ferrimagnetic core with a reluctance gap having a gap width, surrounding a region of the ferromagnetic or ferrimagnetic core adjacent the reluctance gap with a non-conductive, non-magnetic spacer, and wrapping the ferromagnetic or ferrimagnetic core with conductive windings, such that the non-conductive, non-magnetic spacer distances the conductive windings from the reluctance gap.

The method of the preceding paragraph can optionally include, additionally and/or alternatively, any one or more of the following features, configurations, and/or additional components:

Surrounding the region of the ferromagnetic or ferrimagnetic core adjacent the reluctance gap with a non-conductive, non-magnetic spacer comprises wrapping a spacer around the reluctance gap.

The non-conductive, non-magnetic spacer is formed of non-conductive, non-magnetic tape.

The non-conductive, non-magnetic spacer has a width at least as great as the gap width.

The non-conductive, non-magnetic spacer has a height at least twice the gap width.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An inductor comprises:
a ferromagnetic or ferrimagnetic core with a reluctance gap;
a plurality of conductive windings disposed about the ferromagnetic or ferrimagnetic core; and
a spacer separating the plurality of conductive windings from the ferromagnetic or ferrimagnetic core in the immediate vicinity of the reluctance gap, such that the conductive windings are substantially unaffected by fringing flux from the reluctance gap.

2. The inductor of claim 1, wherein the spacer has a semicircular cross-section.

3. The inductor of claim 1, wherein the spacer has a rectangular cross-section.

4. The inductor of claim 1, wherein the spacer is formed of polymer.

5. The inductor of claim 4, wherein the spacer is formed from a Nomex sheet.

6. The inductor of claim 1, wherein the spacer is formed of paper.

7. The inductor of claim 6, wherein the spacer is formed of Kapton tape.

8. The inductor of claim 1, wherein the inductor comprises a plurality of distinct cores, each having a reluctance gap surrounded by a corresponding spacer.

9. The inductor of claim 7, wherein the inductor comprises three legs.

10. The inductor of claim 1, wherein the spacer has a width at least as wide as the reluctance gap.

11. The inductor of claim 10, wherein the spacer has a width no more than twice as wide as the reluctance gap.

12. The inductor of claim 10, wherein the spacer has a width no more than three times as wide as the reluctance gap.

13. The inductor of claim 1, wherein the spacer has a height at least twice a width of the reluctance gap.

14. The inductor of claim 13, wherein the spacer has a height no more than four times a width of the reluctance gap.

15. The inductor of claim 13, wherein the spacer has a height no more than six times a width of the reluctance gap.

16. A method of constructing an inductor, the method comprising:
forming a ferromagnetic or ferrimagnetic core with a reluctance gap having a gap width;
surrounding a region of the ferromagnetic or ferrimagnetic core adjacent the reluctance gap with a non-conductive, non-magnetic spacer; and
wrapping the ferromagnetic or ferrimagnetic core with conductive windings, such that the non-conductive spacer distances the conductive windings from the reluctance gap.

17. The method of claim 16, wherein surrounding the region of the ferromagnetic or ferrimagnetic core adjacent the gap with a non-conductive, non-magnetic spacer comprises wrapping a spacer around the reluctance gap.

18. The method of claim 17, wherein the non-conductive, non-magnetic spacer is formed of non-conductive, non-magnetic tape.

19. The method of claim 17, wherein the non-conductive, non-magnetic spacer has a width at least as great as the gap width.

20. The method of claim 17, wherein the non-conductive, non-magnetic spacer has a height at least twice the gap width.
